(19) United States
(12) Patent Application Publication
(10) Pub. No.: US 2019/0166222 A1
(43) Pub. Date: May 30, 2019

(54) COMMUNICATION SYSTEM

(71) Applicant: TDK CORPORATION, Tokyo (JP)

(72) Inventors: Kazunori HASHIMOTO, Tokyo (JP); Satoshi AKIMOTO, Tokyo (JP)

(73) Assignee: TDK CORPORATION, Tokyo (JP)

(21) Appl. No.: 16/205,745

(22) Filed: Nov. 30, 2018

(30) Foreign Application Priority Data
Nov. 30, 2017 (JP) 2017-230655

(51) Int. Cl. H04L 29/08; H04W 4/80; H04W 4/20

(52) U.S. Cl. CPC H04L 67/2857; H04W 88/04; H04W 4/20; H04W 4/80

(57) ABSTRACT

According to an embodiment, a communication system includes a terminal apparatus and a gateway device. The terminal apparatus intermittently transmits an advertising packet through short-range wireless communication in a broadcast manner, and holds untransmitted data. The gateway device, upon receiving the advertising packet, determines whether the terminal apparatus includes the untransmitted data or not, and when the untransmitted data is included, acquires the untransmitted data from the terminal apparatus for transfer to a server, and transmits to the terminal apparatus a transfer completion record indicating receipt of the untransmitted data by the server.

### CROSS-REFERENCE TO RELATED APPLICATION

This application is based upon and claims the benefit of priority from the prior Japanese Patent Application No. 2017-230655 filed in Japan on Nov. 30, 2017; the entire contents of which are incorporated herein by reference.

### FIELD

The present invention relates to a communication system, and in particular relates to a communication system including a data transfer apparatus configured to acquire information of a terminal apparatus by short-range wireless to transfer the information.

### BACKGROUND

Conventionally, a system has existed which places and manages information on a terminal apparatus at a center apparatus. For example, a system exists in which biological information such as a person's heart rate is measured at a terminal apparatus, the biological information of the terminal apparatus is transmitted to a center apparatus, and the center apparatus collects and manages the biological information of the terminal apparatus.

In such a system, information of the terminal apparatus is transmitted by application software of a personal computer, a smartphone, or the like to a server through a computer communication network. Therefore, a user of the terminal apparatus needs to start application software of a smartphone or the like to transmit biological information and the like.

If data is not transmitted from the user, a server which is a data management apparatus cannot constantly monitor information such as biological information of the user.

So, Japanese Patent Application Laid-Open Publication No. 2017-134011 proposes a system which is improved in constant connectivity or the like of a wearable device to a computer communication network by configuring the wearable device to communicate with a server on a network via a gateway device so as to be able to transmit data to the server without using application software.

When communication with the gateway device becomes available, the wearable device communicates via the gateway device with the server which is a center apparatus, and data of the wearable device is transferred to the server. The server registers and manages the transferred data based on an identifier (ID) of the wearable device.

However, in a system using a gateway device as described above, a problem exists that a processing load of the server and a communication load between the server and the gateway device are high since a server which is a data management apparatus mainly controls data transfer processing.

For example, when communication with a terminal apparatus becomes available, the gateway device inquires of the server about registered data on the terminal apparatus. In response to the inquiry, the server checks registration status of data on the terminal apparatus which has become communicable, and transmits a request to transfer data after already-registered data to the gateway device.

In response to the data transfer request from the server, the gateway device transmits a data transmission request to the terminal apparatus, and acquires data for transfer to the server.

That is, the gateway device inquires of the server about registration status of data on the terminal apparatus which has become communicable, and the server responds to the inquiry to confirm a record number or the like of the terminal apparatus which has become communicable.

A procedure is taken in which the server transmits a data transfer request to the gateway device so that data after the record number of registered data (that is, unregistered data for the server) may be transferred, and the gateway device acquires data from the wearable device based on the transfer request for transfer to the server.

Accordingly, a processing load of the server and a communication load between the server and the gateway device are heavy. In particular, as the number of terminal apparatuses increases, the processing load of the server further increases.

### SUMMARY

So, an object of the present invention is to provide a communication system including a terminal apparatus and a data transfer apparatus configured to acquire information from the terminal apparatus for transfer to a data management apparatus, which can reduce a processing load of the data management apparatus and a communication load between the data transfer apparatus and the data management apparatus to efficiently transmit data of the terminal apparatus to the data management apparatus.

A communication system according to the present invention includes: a terminal apparatus configured to intermittently transmit an existence notification signal through short-range wireless communication in a broadcast manner, and hold predetermined information to be transmitted; and a data transfer apparatus configured to, upon receiving the existence notification signal through the short-range wireless communication, determine whether the terminal apparatus includes the predetermined information, and acquire the predetermined information from the terminal apparatus through the short-range wireless communication for transfer to a data management apparatus, and transmit to the terminal apparatus a reception acknowledgement signal indicating receipt of the predetermined information by the data management apparatus when the terminal apparatus includes the predetermined information.

According to the present invention, it is possible to provide a communication system including a terminal apparatus and a data transfer apparatus configured to acquire information from the terminal apparatus for transfer to a data management apparatus, which can reduce a processing load of the data management apparatus and a communication load between the data transfer apparatus and the data management apparatus to efficiently transmit data of the terminal apparatus to the data management apparatus.

In the present invention, it is preferable that data existence information indicating that the predetermined information exists can be integrated into the existence notification signal. When the predetermined information exists, the terminal apparatus includes the data existence information in the existence notification signal for transmission. When the data existence information is included in the existence notification signal received through the short-range wireless communication, the data transfer apparatus determines that the terminal apparatus includes the predeteiiiiined information, acquires the predetermined information through the short-range wireless communication, and transfers the predetermined information to the data management apparatus.

In the present invention, it is preferable that the terminal apparatus includes at least one sensor. The predetermined information is measured data measured by the at least one sensor, and is data not yet transmitted to the data management apparatus.

In the present invention, it is preferable that the terminal apparatus includes the data existence information in the existence notification signal when an amount of the untransmitted data is equal to or greater than a predetermined amount.

In the present invention, it is preferable that upon receiving a transfer completion record indicating a range of data already transferred to the data management apparatus from the data management apparatus, the data transfer apparatus transfers the transfer completion record to the terminal apparatus, the terminal apparatus holds the transferred transfer completion record, and the data transfer apparatus acquires the transfer completion record from the terminal apparatus, and acquires the untransmitted data from the terminal apparatus based on the acquired transfer completion record for transfer to the data management apparatus.

In the present invention, it is preferable that the terminal apparatus includes at least one operation member, and that the terminal apparatus includes the data existence information in the existence notification signal when the operation member is operated.

In the present invention, it is preferable that the existence notification signal includes group information, and that the data transfer apparatus acquires the predetermined information from the terminal apparatus for transfer to the data management apparatus when the group information matches predetermined group information.

In the present invention, it is preferable that the short-range wireless communication is communication according to a Bluetooth (registered trademark) standard, and that the existence notification signal is an advertising packet in the Bluetooth (registered trademark) standard.

### BRIEF DESCRIPTION OF THE DRAWINGS

FIG. 1 is an external view of a terminal apparatus 1 related to an embodiment of the present invention;

FIG. 2 is an external view of a gateway device 2 related to the embodiment of the present invention;

FIG. 3 is a block diagram showing a hardware configuration of a body part 11 of the terminal apparatus 1 related to the embodiment of the present invention;

FIG. 4 is a configuration diagram showing a software configuration for performing various functions of the terminal apparatus I related to the embodiment of the present invention;

FIG. 5 is a block diagram showing an internal configuration of the gateway device 2 related to the embodiment of the present invention;

FIG. 6 is a configuration diagram of a communication system related to the embodiment of the present invention;

FIG. 7 is a flowchart showing an example flow of processing regarding measurement and recording in the terminal apparatus 1 related to the embodiment of the present invention;

FIG. 8 is a flowchart showing an example flow of reset processing of a transfer data existence flag in the terminal apparatus 1 related to the embodiment of the present invention;

FIG. 9 is a flowchart showing an example flow of data transmission processing in the terminal apparatus 1 related to the embodiment of the present invention;

FIG. 10 is a diagram for explaining a construction of an advertising packet related to the embodiment of the present invention;

FIG. 11 is a flowchart showing an example flow of transmission/reception processing in the gateway device 2 related to the embodiment of the present invention; and

FIG. 12 is a flowchart showing an example flow of transmission/reception processing of a transfer completion record TR in the terminal apparatus 1 related to the embodiment of the present invention.

### DETAILED DESCRIPTION

Hereinafter, an embodiment of the present invention will be described with reference to the drawings.

### (System Configuration)

A communication system related to the embodiment is configured to include a plurality of terminal apparatuses 1 and a plurality of gateway devices 2.

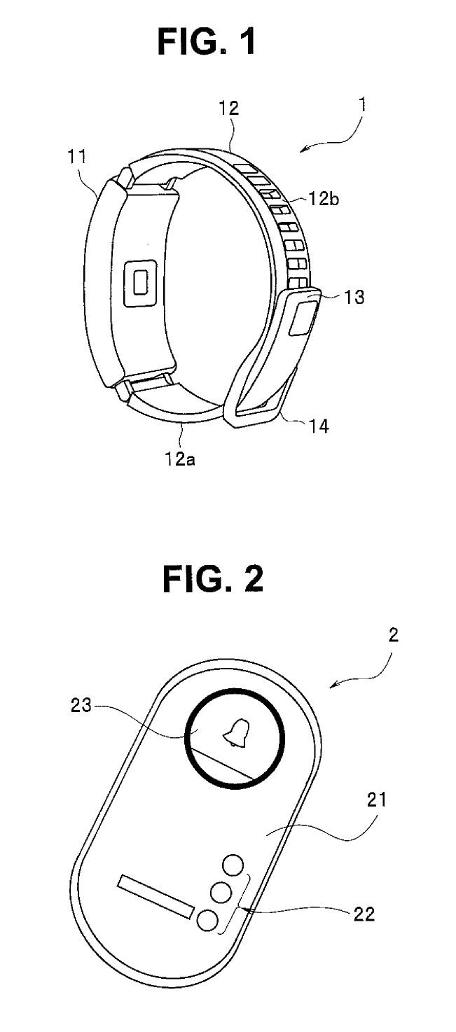

FIG. 1 is an external view of a terminal apparatus 1 related to the embodiment. The terminal apparatus 1 is configured to have a body part 11 and a wearing part 12. Here, the terminal apparatus 1 is a wristband-type wearable device which is used by being worn around a forearm wrist of a target person, later-described biological information or the like of whom is to be measured, that is, a person wearing the terminal apparatus 1 (hereinafter referred to as a user).

The wearing part 12 is composed of two bands 12a, 12b which are attached to both ends in a longitudinal direction of the body part 11. The two bands 12a, 12b are each formed in an elongate strip shape, and have clasps 13, 14 at tips. The wearing part 12 is worn around the user's forearm so that the two bands 12a, 12b are wound around the user's forearm. The user places the body part 11 on outside of a forearm (on a back side of a hand), leads each of the two bands 12a, 12b toward inside of the forearm (a palm side of the hand), and latches the clasps 13, 14 together for wearing around the forearm.

Although not shown in FIG. 1, the terminal apparatus 1 is provided with operation buttons and a display as a user interface.

FIG. 2 is an external view of a gateway device 2 related to the embodiment. As shown in FIG. 2, the gateway device 2 is a portable apparatus in which a body 21 having an oval shape is provided with an indication lamp part 22 composed of a plurality of light emitting diodes (hereinafter referred to as LEDs) and an operation button 23.

A plurality of gateway devices 2 are arranged within an activity range of a user wearing the terminal apparatus 1 in a predetermined area such as one or more buildings. For example, a plurality of gateway device 2 are installed within an activity range of the user in one or more buildings such as personal housing, housing complex, hospitals, or elderly care facilities.

### (Internal Configuration of Terminal Apparatus 1)

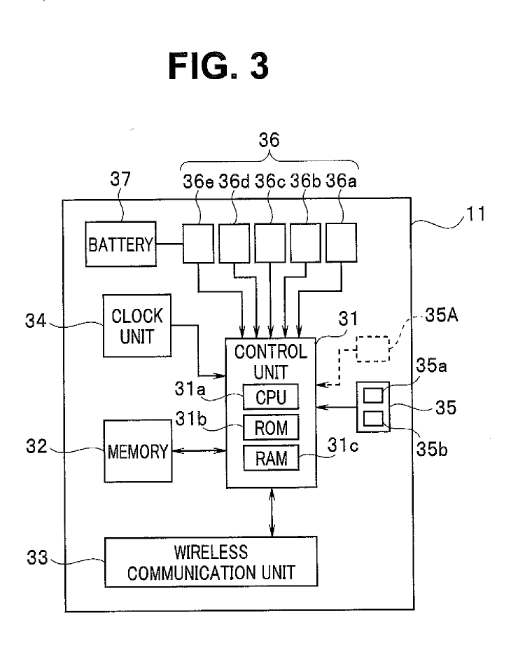

FIG. 3 is a block diagram showing a hardware configuration of the body part 11 of the terminal apparatus 1 related to the embodiment.

The body part 11 of the terminal apparatus 1 has a control unit 31, a memory 32, a wireless communication unit 33, a clock unit 34, an operation display unit 35 as a user interface, a sensor unit 36 including various sensors, and a battery 37.

The control unit 31 has a central processing unit (hereinafter referred to as a CPU) 31a, a ROM 31b, a RAM 31c, and various interfaces (hereinafter abbreviated as I/Fs) not shown.

Software programs and data for various functions of the terminal apparatus 1 are recorded in the ROM 31b of the control unit 31. The various functions include a function to calculate desired data from output signals of the various sensors or the like, a communication function to transmit the calculated data to the gateway device 2, and the like. Note that the ROM 31b may be a rewritable nonvolatile memory such as a flash memory.

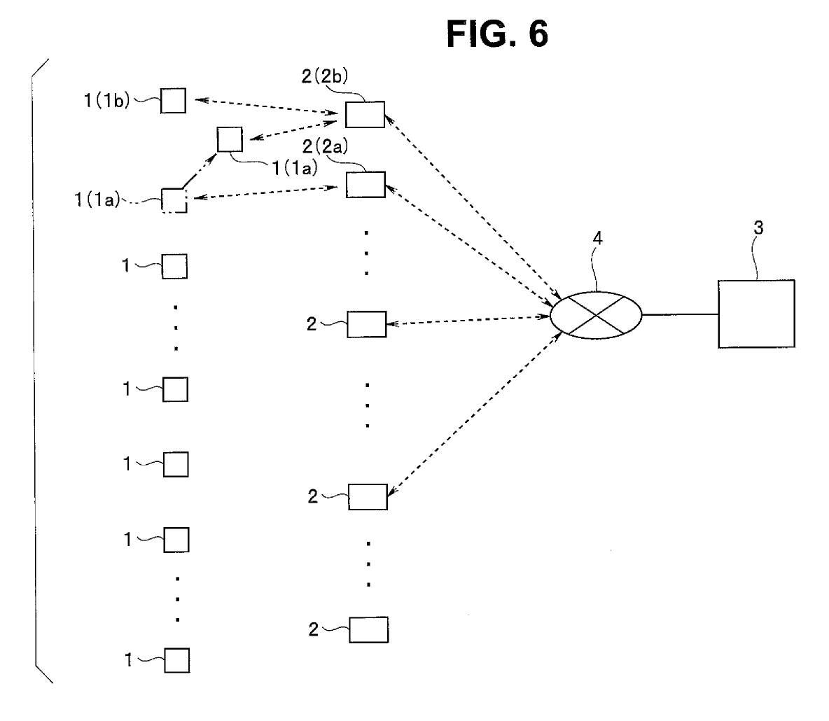

The memory 32 is a rewritable nonvolatile memory such as a flash memory, and is a storage unit for temporarily storing data detected by the various sensors. A transfer completion record TR described later is also stored in the memory 32. As described later, the transfer completion record TR is information indicating a range of data transferred to a server 3 (FIG. 6) described later, and is transmitted from the server 3 (FIG. 6) and stored in the memory 32.

The wireless communication unit 33 is a circuit for short-range wireless communication for communicating with the gateway device 2 within a predetermined distance. A short range in short-range wireless communication is, for example, a range of 100 m or less.

Here, the wireless communication unit 33 includes a circuit for wireless communication according to a Bluetooth (registered trademark) standard. The wireless communication unit 33 operates under control of the control unit 31 to perform short-range wireless communication with the gateway device 2. That is, short-range wireless communication between the terminal apparatus 1 and the gateway device 2 is communication according to the Bluetooth (registered trademark) standard.

The clock unit 34 is a circuit configured to generate and output time information. An output signal including the time information of the clock unit 34 is inputted to the control unit 31 via an I/F not shown, and the CPU 31a can acquire time information of a year, month, day and time from the clock unit 34. As described later, measured data of the various sensors is stored in the memory 32 together with the time information of the clock unit 34, and transmitted to the gateway device 2.

The operation display unit 35 has an indicator 35a such as an LED, and an operation button 35b which is a member operated by the user. Note that the indicator 35a and the operation button 35b of the operation display unit 35 may be, for example, on a display apparatus with a touch panel.

The sensor unit 36 includes a plurality of sensors and a measurement circuit. Here, the sensor unit 36 includes an acceleration sensor 36a, a temperature sensor 36b, a pulse wave sensor 36c, an ultraviolet sensor 36d and a battery voltage measurement circuit 36e.

The acceleration sensor 36a is a sensor configured to detect acceleration in three axial directions orthogonal to each other. The acceleration sensor 36a is used to detect an arm motion of the user wearing the terminal apparatus 1 to detect the user's step count and calorie consumption.

The temperature sensor 36b is a sensor used to detect body surface temperature of the user wearing the terminal apparatus 1. The temperature sensor 36b is provided at a position where arm temperature can be detected on the body part 11 when the terminal apparatus 1 is worn around the user's arm.

The pulse wave sensor 36c is a sensor used to detect a pulse of the user wearing the terminal apparatus 1. The pulse wave sensor 36c is also provided at a position where the user's pulse wave can be detected on the body part 11 when the terminal apparatus 1 is worn around the user's arm.

The ultraviolet sensor 36d is a sensor used to detect an amount of ultraviolet rays striking the terminal apparatus 1. The ultraviolet sensor 36d is provided at a position where ultraviolet rays from outside can be detected on the body part 11 when the terminal apparatus 1 is worn around the user's arm.

The battery voltage measurement circuit 36e is a circuit connected to the battery 37 and used to measure output voltage of the battery 37.

An output signal of each sensor of the sensor unit 36 is inputted to the control unit 31 via an IIF not shown. An output signal of the battery voltage measurement circuit 36e is also inputted to the control unit 31 via an I& not shown.

The battery 37 is, for example, a secondary battery, and is a power supply for supplying power to various circuits of the teuninal apparatus 1.

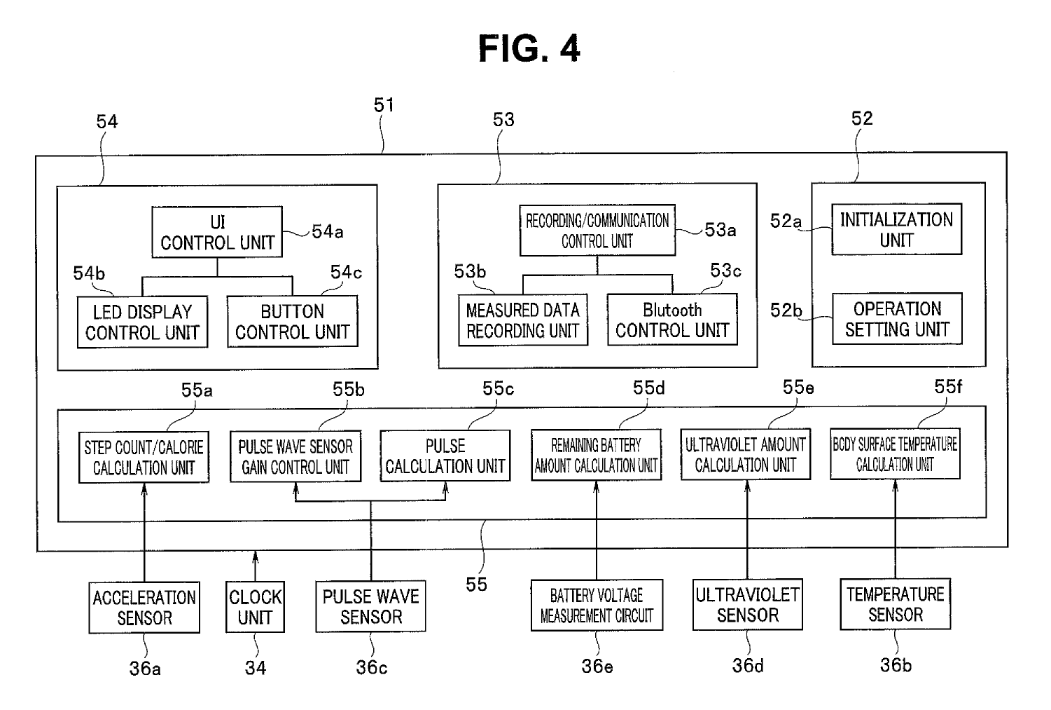

FIG. 4 is a configuration diagram showing a software configuration for performing various functions of the terminal apparatus 1.

As shown in FIG. 4, software 51 of the terminal apparatus 1 includes an overall control unit 52 for controlling the overall terminal apparatus 1, a recording/communication unit 53, a user interface (hereinafter abbreviated as a UI) unit 54, and a data measurement unit 55. The overall control unit 52, the recording/communication unit 53, the UI unit 54 and the data measurement unit 55 are software programs stored in the ROM 31b, and the CPU 31a reads and executes the programs from the ROM 31b to perform respective functions.

An output signal of each sensor of the sensor unit 36 is inputted to the control unit 31 to be converted into digital data. An output signal of the battery voltage measurement circuit 36e and an output signal of the clock unit 34 are also inputted to the control unit 31 to be converted into digital data.

The overall control unit 52 includes an initialization unit 52a and an operation setting unit 52b. The initialization unit 52a is a program for initializing the terminal apparatus 1 when the terminal apparatus 1 is powered on. The operation setting unit 52b is a program for making settings related to various operation in order to execute various processing according to an operation state of the teiiiiinal apparatus 1. That is, the overall control unit 52 controls operation of the overall terminal apparatus 1.

The recording/communication unit 53 includes a recording/communication control unit 53a, a measured data recording unit 53b and a Bluetooth (registered trademark) control unit 53c.

The recording/communication control unit 53a executes control processing of recording and communication of data in the recording/communication unit 53.

The measured data recording unit 53b performs processing for recording measured data of each sensor of the sensor unit 36 in the memory 32.

The Bluetooth (registered trademark) control unit 53c performs control processing for perfoniiing short-range wireless communication according to the Bluetooth (registered trademark) communication standard with the gateway device 2 using the wireless communication unit 33.

Therefore, the recording/communication control unit 53a controls operation of the measured data recording unit 53b and the Bluetooth (registered trademark) control unit 53c under control of the overall control unit 52.

The terminal apparatus 1 performs processing for notifying its own existence to the gateway device 2. In the embodiment, the terminal apparatus 1 transmits an advertising packet according to a Bluetooth (registered trademark) Low Energy (a standard of Bluetooth (registered trademark) 4.0 or later) communication standard to perform processing for notifying its own existence to other Bluetooth (registered trademark) devices within a range where short-range communication is possible.

The advertising packet is an existence notification signal specified in the Bluetooth (registered trademark) communication standard, and is intermittently transmitted in a broadcast manner. In other words, the advertising packet is a beacon signal.

That is, the terminal apparatus 1 intermittently transmits the advertising packet as an existence notification signal through short-range wireless communication in a broadcast manner

The UI unit 54 includes a UI control unit 54a, an LED display control unit 54b and a button control unit 54c.

The UI control unit 54a performs processing related to the operation display unit 35, and controls the LED display control unit 54b and the button control unit 54c.

The LED display control unit 54b performs control for changing an indication state of the indicator 35a according to an instruction of the UI control unit 54a.

The button control unit 54c detects an operation performed on the operation button 35b by the user, and supplies operation infotination to the UI control unit 54a.

Therefore, the UT control unit 54a controls operation of the LED display control unit 54b and the button control unit 54c under control of the overall control unit 52.

The data measurement unit 55 includes a step count/calorie calculation unit 55a, a pulse wave sensor gain control unit 55b, a pulse calculation unit 55c, a remaining battery amount calculation unit 55d, an ultraviolet amount calculation unit 55e and a body surface temperature calculation unit 55f.

The step count/calorie calculation unit 55a calculates the user's step count and calorie consumption from an output signal of the acceleration sensor 36a.

The pulse wave sensor gain control unit 55b controls gain of the pulse wave sensor 36c.

The pulse calculation unit 55c calculates a pulse from an output signal of the pulse wave sensor 36c.

The remaining battery amount calculation unit 55d calculates a remaining battery amount of the battery 37 from data of output voltage of the battery 37 measured by the battery voltage measurement circuit 36e.

The ultraviolet amount calculation unit 55e calculates an ultraviolet amount from an output signal of the ultraviolet sensor 36d.

The body surface temperature calculation unit 55f calculates the user's body surface temperature from an output signal of the temperature sensor 36b.

As described above, the data measurement unit 55 calculates predetermined measured data from an output signal of each sensor and circuit.

### (Configuration of Gateway Device)

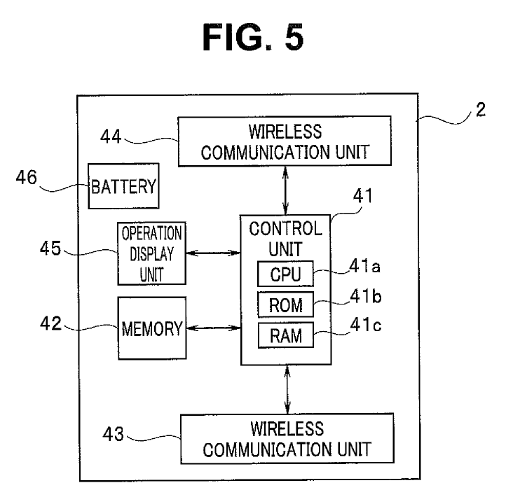

FIG. 5 is a block diagram showing an internal configuration of the gateway device 2 related to the embodiment.

The gateway device 2 has a control unit 41, a memory 42, wireless communication units 43, 44, an operation display unit 45 as a user interface, and a battery 46.

The control unit 41 has a CPU 41a, a ROM 41b, a RAM 41c, and various interfaces (hereinafter abbreviated as I/Fs) not shown.

Software programs and data for various functions of the gateway device 2 are recorded in the ROM 41b of the control unit 31. The various functions include functions to communicate with the terminal apparatus 1 and to communicate with the server 3 (FIG. 6) and the like. Note that the ROM 41b may be a rewritable nonvolatile memory such as a flash memory.

The memory 42 is a rewritable nonvolatile memory such as a flash memory, and is a storage unit for storing various information for each communication. Data from the terminal apparatus 1 is temporarily stored in the memory 42 or the RAM 41c.

The wireless communication unit 43 is a circuit for short-range wireless communication for communicating with the terminal apparatus 1 within a predetermined distance. Here, the wireless communication unit 43 includes a circuit for wireless communication according to the Bluetooth (registered trademark) standard. The wireless communication unit 43 operates under control of the control unit 41 to perform short-range wireless communication with the terminal apparatus 1.

The gateway device 2 can receive the above-described advertising packet from the terminal apparatus 1 through Bluetooth (registered trademark) communication.

The wireless communication unit 44 is a circuit for perfoi ning data communication with the server 3 described later, and is a circuit for wireless communication in a cellular system used for mobile phones or the like. The wireless communication unit 44 operates under control of the control unit 41 to communicate with the server 3. That is, the wireless communication unit 44 includes a circuit for connecting to the Internet which is a computer communication network via a nearby wireless base station to communicate with the server 3.

The operation display unit 45 includes the indication lamp part 22 and the operation button operated by the user shown in FIG. 2.

The battery 46 is, for example, a secondary battery or the like, and is a power supply for supplying power to various circuits of the gateway device 2.

FIG. 6 is a configuration diagram of a communication system of the embodiment.

The server 3 is a center apparatus which is connected to a network 4 such as the Internet which is a computer communication network, and collects and manages data of a plurality of terminal apparatuses 1. Each gateway device 2 has a wireless communication function for connecting to the Internet as described above, and is capable of connecting to the network 4 using the wireless communication function, and capable of communicating with the server 3.

By distributedly installing a plurality of gateway devices 2 in one or more buildings, each terminal apparatus 1 can communicate with any gateway device 2 through short-range wireless communication, and the gateway device 2 can transfer information on a pulse or the like of a user of each terminal apparatus 1 to the server 3. Therefore, the server 3 is configured to be able to constantly monitor predetermined information such as a pulse of a user in a predetermined area.

In the embodiment, although the sensor unit 36 has a plurality of sensors, the number of the sensors may be at least one, the predetermined information transmitted by a terminal apparatus 1 is measured data measured by at least one sensor, and is data not yet transmitted to the server 3 which is a data management apparatus.

Each terminal apparatus 1 and each gateway device 2 are set so as to belong to a predetermined group. A group is defined by a UUID (universally unique identifier), and each terminal apparatus 1 and each gateway device 2 have set UUID information in the memories 32 and 42, respectively.

A plurality of terminal apparatuses 1 having a same UUID form one group, and a plurality of gateway devices 2 having the same UUID consequently belong to the same group as the plurality of terminal apparatuses 1. Therefore, by setting a UUID, which is group information, to each terminal apparatus 1 and each gateway device 2, each gateway device 2 can acquire data only from terminal apparatuses 1 having a same UUID for transfer to the server 3. In other words, each gateway device 2 does not acquire data of a terminal apparatus 1 having a UUID different from its own UUID.

The server 3 has and executes a predetermined application program, and data of a terminal apparatus 1 from a gateway device 2 is collected under the application program, and is recorded in a storage apparatus of the server 3.

FIG. 6 shows that a user having a terminal apparatus 1a (shown by a two-dot chain line) having communicated with a gateway device 2a moves to communicate with another nearby gateway device 2b. As a result, data of the terminal apparatus 1a is acquired by the gateway device 2b and transferred to the server 3.

Since each terminal apparatus 1 communicates with a gateway device 2 using a packet including ID information of the terminal apparatus 1 such as a MAC address, the gateway device 2 can individually communicate with each terminal apparatus 1.

Although the gateway device 2b communicates with a terminal apparatus 1b in FIG. 6, even when the gateway device 2b has come to communicate with the terminal apparatus 1a, the gateway device 2b can distinguish the terminal apparatuses 1a and 1b based on the ID information to individually communicate with the terminal apparatuses la and lb to acquire respective data.

Therefore, as long as a terminal apparatus 1 is in a predetermined area where it is possible to communicate with a plurality of gateway devices 2, any gateway device 2 can communicate with the terminal apparatus 1.

Data measurement processing in the terminal apparatus 1 and communication processing between the terminal apparatus 1 and the gateway device 2 will be described below.

### (Operation)

First, measurement processing and recording processing in the terminal apparatus 1 will be described.

### (Measurement and Recording Processing in Terminal Apparatus)

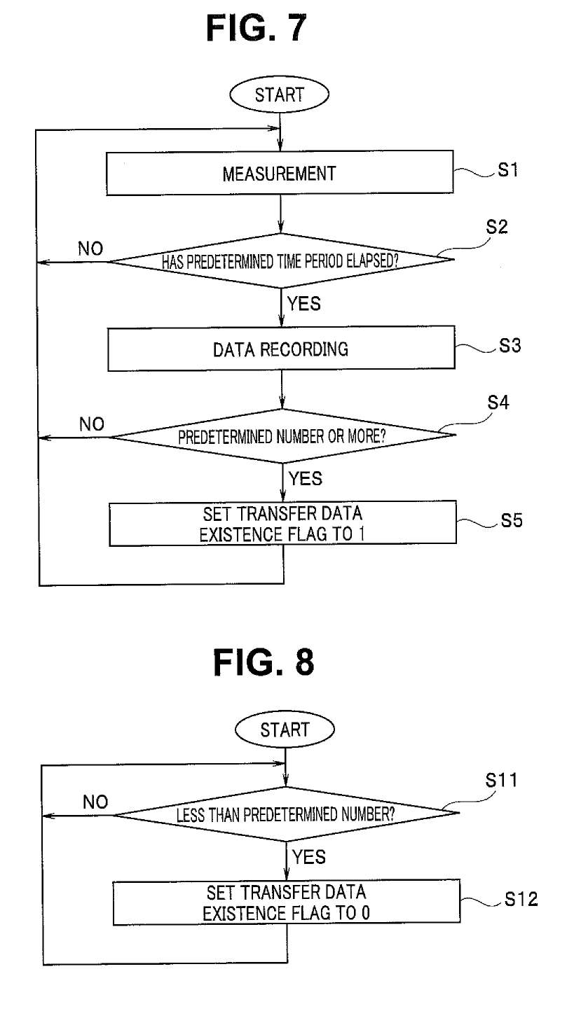

FIG. 7 is a flowchart showing an example flow of processing regarding measurement and recording in the terminal apparatus 1. The processing in FIG. 7 is performed by the CPU 31a reading a program stored in the ROM 31b, developing the program on the RAM 31c and executing the program.

The control unit 31 executes measurement processing (step (hereinafter abbreviated as S) 1). The measurement processing is performed by the data measurement unit 55 which receives an output signal from each sensor of the sensor unit 36.

After S1, the control unit 31 determines whether a predetermined time period has elapsed (S2). When the predetermined time period has not elapsed (S2:NO), the processing returns to S1. The predetermined time period in S2 is, for example, one minute.

When the predetermined time period has elapsed (S2:YES), the control unit 31 executes data recording processing (S3). The data recording processing is performed by the measured data recording unit 53b, and data of a plurality of sensors is recorded in the memory 32.

Here, the data of the plurality of sensors is stored in the memory 32 as one record in association with a record number. The record number is incremented by one each time one record is added and recorded in the memory 32.

Each record is given time data outputted from the clock unit 34. Therefore, each record includes time data at a predetermined time period interval.

Note that the time data outputted from the clock unit 34 may be given for each data of each sensor.

The control unit 31 receives an output signal of each sensor through the data measurement unit 55 for one minute to calculate measured data such as an activity amount, a heart rate, and an ultraviolet amount for one minute. Respective calculated data of a step count, calorie consumption, a pulse rate, an ultraviolet amount and body surface temperature are stored in the memory 32 as one record in association with the time data.

After the data recording processing, the control unit 31 determines whether the number of records of untransmitted data among recorded data has become equal to or greater than a predetermined number (S4). When the number of records of untransmitted data has become equal to or greater than the predetermined number or a predetermined amount, the terminal apparatus 1 sets a transfer data existence flag SF to “1” which indicates that data to be transmitted exists (S5). The transfer data existence flag SF is written in a predetermined storage area of the memory 32 as internal information. The predetermined number or the predetermined amount is, for example, 50.

That is, the terminal apparatus 1 holds untransmitted data as predetermined information to be transmitted. When the amount of untransmitted data has reached the predetermined amount, the terminal apparatus 1 sets the transfer data existence flag SF to “1”.

When the number of records of untransmitted data has not become equal to or greater than the predetermined number (S4:NO), the processing returns to S1, and processing from S1 to S3 is repeated.

When the number of records of untransmitted data has become equal to or greater than the predetermined number (S4:YES), the transfer data existence flag SF is set to “1” in a predetermined storage area of the memory 32, and then the processing returns to S1. The transfer data existence flag SF is internal information of the terminal apparatus 1 as described above.

As described above, the control unit 31 constantly monitors whether the number of records of untransmitted data among recorded data has become equal to or greater than the predetermined number or not, and sets the transfer data existence flag to “1” when the number of records of untransmitted data has become equal to or greater than the predetermined number.

Note that the control unit 31 performs processing of monitoring the number of records of untransmitted data, and separately performs setting the transfer data existence flag to “0” when the number of records of untransmitted data has become less than the predetermined number.

FIG. 8 is a flowchart showing an example flow of reset processing of the transfer data existence flag in the terminal apparatus 1. The processing in FIG. 8 is performed by the CPU 31a reading a program stored in the ROM 31b, developing the program on the RAM 31c and executing the program when the transfer data existence flag SF is “1”.

The control unit 31 determines whether the number of records of untransmitted data has become less than the predetermined number (S11).

When the number of records of untransmitted data has not become less than the predetermined number (S11:NO), the control unit 31 does nothing.

When the number of records of untransmitted data has become less than the predetermined number (S11:YES), the control unit 31 sets the transfer data existence flag SF to “0” (S12).

As described above, the control unit 31 monitors the number of records of untransmitted data while performing data recording processing, sets the transfer data existence flag SF to “1” when the number of the records has become equal to or greater than the predetermined number, and sets the transfer data existence flag SF to “0” when the number of the records has become less than the predetermined number.

Each terminal apparatus 1 performs the above processing to perform measurement processing and recording processing of various data.

### (Transmission Processing of Advertising Packet by Terminal Apparatus 1)

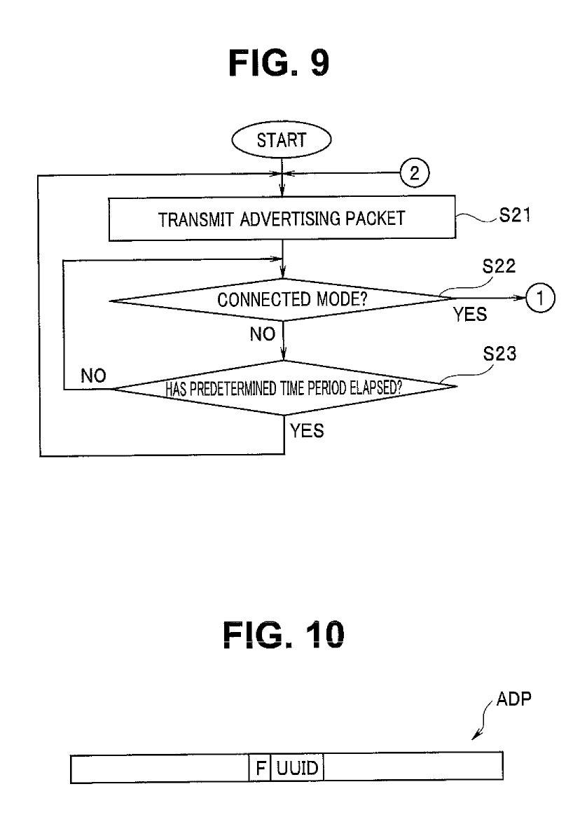

FIG. 9 is a flowchart showing an example flow of data transmission processing in the terminal apparatus 1.

The control unit 31 of the terminal apparatus 1 transmits an advertising packet ADP in Bluetooth (registered trademark) communication (S21). As described above, the advertising packet ADP is an existence notification signal, and is intermittently transmitted in a broadcast manner.

Although the control unit 31 intermittently transmits the advertising packet ADP at a predetermined cycle, the advertising packet ADP is transmitted inclusive of information indicating presence/absence of data to be transmitted, that is, untransmitted data.

The advertising packet ADP is composed of 31 bytes of data, and a flag F is included in the 31 bytes as infoiniation indicating presence/absence of data to be transmitted. The flag F is data existence information indicating whether data to be transmitted exists in the terminal apparatus 1. When the transfer data existence flag SF which is the above-described internal information is “1”, the flag F with a value of “1” is included in the advertising packet ADP.

That is, the data existence information (the flag F) indicating that the predetermined information exists can be integrated into the advertising packet ADP which is the existence notification signal. When untransmitted data which is the predetermined information exists, the terminal apparatus 1 performs transmission with the flag F which is the data existence information included in the advertising packet ADP.

In the embodiment, when the amount of untransmitted data has become equal to or greater than the predetermined amount, the terminal apparatus 1 performs transmission with the flag F as the data existence information included in the advertising packet ADP which is the existence notification signal.

When the transfer data existence flag SF which is the above-described internal information is “0”, the flag F with a value of “0” is included in the advertising packet ADP.

The advertising packet ADP also includes a UUID indicating a group and an ID of the terminal apparatus 1 such as a MAC address.

FIG. 10 is a diagram for explaining a construction of an advertising packet. As shown in FIG. 10, the advertising packet ADP includes the flag F indicating presence/absence of data to be transmitted and a UUID indicating a group.

As described above, since communication is performed between the terminal apparatus 1 and the gateway device 2 inclusive of ID information such as a MAC address, the terminal apparatus 1 and the gateway device 2 can identify each other device. The ID information is not included in the advertising packet ADP, but included in a communication packet including the advertising packet ADP.

When the advertising packet ADP is transmitted to be received at the gateway device 2, the gateway device 2 checks the value of the flag F, and determines that communication is necessary when the flag F is “1” to start communication with the terminal apparatus 1 to enter a connected mode. When the flag F is “0”, the gateway device 2 determines that communication is not necessary, and communication with the terminal apparatus 1 is not started.

Therefore, after S21, the control unit 31 determines whether the connected mode has been entered or not based on whether information for communication has been transmitted from the gateway device 2 or not (S22).

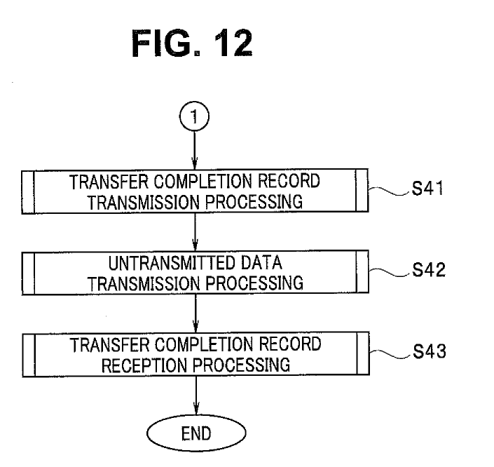

When the terminal apparatus 1 enters the connected mode to the gateway device 2 (S22:YES), the processing transitions to processing in FIG. 12.

When the terminal apparatus 1 does not enter the connected mode (S22:NO), the control unit 31 determines whether the predetermined time period has elapsed (S23). The predetermined time period in S23 is, for example, one second.

When the predetermined time period has not elapsed (S23:NO), the processing returns to S22. When the predetermined time period has elapsed (S23:YES), the processing returns to S21.

Therefore, the terminal apparatus 1 intermittently transmits the advertising packet ADP in a broadcast manner, and repeats the processing in S21 until receiving a connection for communication from the gateway device 2.

### (Transmission/Reception Processing in Gateway Device)

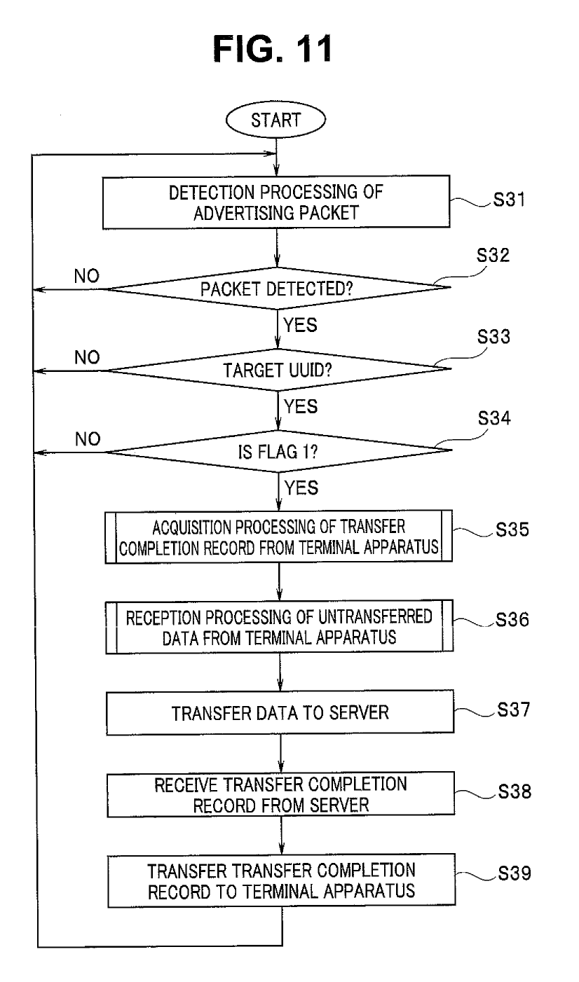

FIG. 11 is a flowchart showing an example flow of transmission/reception processing in the gateway device 2.

The control unit 41 of the gateway device 2 performs detection processing of the advertising packet ADP (S31). The detection processing of the advertising packet ADP is executed at a predetermined cycle, for example, a cycle of two seconds.

The control unit 41 determines whether the advertising packet ADP has been detected, that is, found or not (S32), and when the advertising packet ADP has not been detected (S32:NO), the processing returns to S31 to repeat detection processing of the advertising packet ADP.

When the advertising packet ADP has been found (S32:YES), the control unit 41 determines whether a UM in the received advertising packet ADP is a target UUID or not (S33). As described above, the target UUID is group information which is set in advance as targets from which the gateway device 2 acquires data of terminal apparatuses 1. That is, the gateway device 2 determines based on the UUID whether the terminal apparatus 1 belongs to a set group.

When the UUID in the received advertising packet ADP is not the target UUID (S33:NO), the processing returns to S31.

When the UUID in the received advertising packet ADP is the target UUID (S33:YES), the control unit 41 determines whether the flag F indicating presence/absence of untransmitted data is “1” or not (S34).

When the flag F indicating presence/absence of untransmitted data is not “1” (S34:NO), the processing returns to S31. In the case, the terminal apparatus 1 has the target UUID, but may not have data to be transmitted.

When the flag F indicating presence/absence of untransmitted data is “1” (S34:YES), the control unit 41 of the gateway device 2 transitions to a one-to-one communication state with the terminal apparatus 1, and executes acquisition processing of a transfer completion record for acquiring a transfer completion record TR from the terminal apparatus 1 (S35). When transitioning to a one-to-one communication state with the terminal apparatus 1, the gateway device 2 enters a connected mode with the terminal apparatus 1.

The transfer completion record TR is information written by the server 3, includes a record number of data transferred last, and is information indicating a range of transferred data or transferred last data. As described above, data of various sensors recorded periodically is given a record number to be stored in the memory 32. If a record number is, for example, a number in ascending order, the transfer completion record TR is a last record number of data of the terminal apparatus 1 transferred to the server 3.

Acquisition of the transfer completion record TR in processing of S35 is performed by the gateway device 2 transmitting a request to transmit the transfer completion record TR to the terminal apparatus 1, and the terminal apparatus 1 responding to the transmission request to read and transmit the transfer completion record TR recorded in the memory 32.

When a maximum amount of a data amount which the terminal apparatus 1 can transmit to the gateway device 2 in one communication is determined in advance, untransmitted data is transmitted from the terminal apparatus 1 to the gateway device 2 within a range of the maximum transmission data amount.

The control unit 41 performs reception processing of untransferred data from the terminal apparatus 1 based on the transfer completion record TR (S36).

Specifically, the control unit 41 transmits a transmission request command to the terminal apparatus 1 so that data may be transmitted by a predetermined number from data with record numbers after a record number of already-transferred last data indicated by the transfer completion record TR, and acquires the data from the terminal apparatus 1.

After S36, the control unit 41 transfers the received data to the server 3 (S37).

As described above, the gateway device 2 which is a data transfer apparatus acquires the transfer completion record TR from the terminal apparatus 1 (S35), and acquires untransmitted data from the terminal apparatus 1 based on the acquired transfer completion record TR (S36) for transfer to the server 3 which is a data management apparatus (S37). In particular, here, when UUIDs which are group information match each other between the terminal apparatus 1 and the gateway device 2, the gateway device 2 acquires untransmitted data from the terminal apparatus 1 (S36) for transfer to the server 3 which is a data management apparatus.

The server 3 registers the received data in the storage apparatus, and transmits the transfer completion record TR to the gateway device 2 when registration is completed.

The control unit 41 receives the transfer completion record TR from the server 3 (S38), and transfers the transfer completion record TR to the terminal apparatus 1 (S39).

That is, upon receiving from the server 3 the transfer completion record TR indicating a range of data already transferred to the server 3 (S38), the gateway device 2 transfers the transfer completion record TR to the terminal apparatus 1 (S39). After S39, the processing returns to S31.

For example, when the transfer completion record obtained in S35 is “50”, the control unit 41 acquires data with record numbers of “51” and later within a range of at most 50 from the terminal apparatus 1 (S36) for transfer to the server 3. When the gateway device 2 acquires the 50 data from the terminal apparatus 1 for transfer to the server 3, the server 3 calculates and holds “100” as the transfer completion record TR, and the transfer completion record TR of “100” is transferred to the terminal apparatus 1 via the gateway device 2 to be held in the memory 32.

Note that the gateway device 2 and the terminal apparatus 1 communicate with each other so that the untransmitted data is acquired by the gateway device 2 when the number of records of untransmitted data in the terminal apparatus 1 has exceeded the predetermined number (S4) after the terminal apparatus 1 had transmitted at most 50 data, since the flag F is also “1” in next communication.

As described above, the gateway device 2 which is a data transfer apparatus determines whether or not the terminal apparatus 1 has the predetermined information which is untransmitted data upon receiving the advertising packet ADP through short-range wireless communication (S34). When the terminal apparatus 1 has the predetermined information, the gateway device 2 acquires the predetermined information through short-range wireless communication from the terminal apparatus 1 (S35) for transfer to the server 3 (S37), and transmits to the terminal apparatus 1 the transfer completion record TR which is a reception acknowledgement signal indicating that the server 3 has received the predetermined information (S39).

Here, when the advertising packet ADP received through short-range wireless communication includes the flag F as data existence information, the gateway device 2 determines that the terminal apparatus 1 has the predetermined information, that is, untransmitted data, and acquires the predetermined information through short-range wireless communication for transfer to the server 3 which is the data management apparatus.

### (Transmission/Reception Processing of Transfer Completion Record by Terminal Apparatus)

FIG. 12 is a flowchart showing an example flow of transmission/reception processing of the transfer completion record TR in the terminal apparatus 1.

When determined to be in the connected mode in S22, the control unit 31 performs transmission processing of the transfer completion record TR in response to an instruction from the gateway device 2 (S41).

Specifically, upon receiving a request to transmit the transfer completion record TR from the gateway device 2, the terminal apparatus 1 reads the transfer completion record TR stored in the memory 32 for transmission to the gateway device 2.

Since processing in S41 is executed by the Bluetooth (registered trademark) control unit 53c in response to the request to transmit the transfer completion record TR from the gateway device 2 (S25), the processing is not executed if the terminal apparatus 1 does not receive the request to transmit the transfer completion record TR.

The control unit 31 executes transmission processing of untransmitted data in response to an instruction from the gateway device 2 (S42).

Specifically, upon receiving a request to transmit untransmitted data from the gateway device 2, the terminal apparatus 1 reads untransmitted data stored in the memory 32 for transmission to the gateway device 2.

Since processing in S42 is executed by the Bluetooth (registered trademark) control unit 53c in response to the request to transmit untransmitted data from the gateway device 2 (S36), the processing is not executed if the terminal apparatus 1 does not receive the request to transmit untransmitted data.

Note that untransmitted data is held in the terminal apparatus 1 until being transmitted, but already-transmitted data is deleted. However, the terminal apparatus 1 may be configured to hold even already-transmitted data without deletion by a predetermined amount or for a predetermined time period after transmission.

The control unit 31 executes reception processing of the transfer completion record TR in response to an instruction from the gateway device 2 (S43).

Specifically, upon receiving the transfer completion record TR from the gateway device 2, the terminal apparatus 1 writes the received transfer completion record TR in a predetermined storage area of the memory 32. That is, the terminal apparatus 1 writes the transferred transfer completion record TR in the memory 32 as a reception acknowledgement signal for holding.

Since processing in S43 is executed by the Bluetooth (registered trademark) control unit 53c upon receiving the transfer completion record TR from the gateway device 2 (S39), the processing is not executed if the terminal apparatus 1 does not receive the transfer completion record TR.

For example, if a record number of “50” is stored in the memory 32 of the terminal apparatus 1 as the transfer completion record TR, “50” is transmitted as the transfer completion record TR in S41. When the terminal apparatus 1 has untransmitted data, the gateway device 2 acquires a predetermined number of data from the terminal apparatus 1 in S42 for transfer to the server 3.

When acquiring data from the terminal apparatus 1 for registration in its own storage apparatus, the server 3 transmits a registered last record number to the gateway device 2 as the transfer completion record TR. The gateway device 2 transfers the transfer completion record TR to the terminal apparatus 1, so that the transfer completion record TR indicating the last record number of data registered in the server 3 is stored in the terminal apparatus 1 through processing in S43.

The transfer completion record TR stored in the terminal apparatus 1 is transmitted to the gateway device 2 at next data transfer and transferred to the server 3.

As described above, when the number of records of untransmitted data is equal to or greater than a maximum transmission data amount of the terminal apparatus 1, the untransmitted data is transmitted from the terminal apparatus 1 to the gateway device 2 at next communication between the terminal apparatus 1 and the gateway device 2.

As described above, the terminal apparatus 1 is worn around the user's arm, and the control unit 31 acquires the user's biological information or the like from an output signal of each sensor at a predetermined cycle for storage in the memory 32. Although the control unit 31 transmits various data stored in the memory to the gateway device 2, the transfer data existence flag SF is set in a predetermined storage area of the memory 32 when untransmitted data exists.

Although the terminal apparatus 1 and the gateway device 2 can communicate with each other through short-range wireless communication, the terminal apparatus 1 intermittently transmits the existence notification signal (the advertising packet described above) in a broadcast manner inclusive of the flag F.

Only when the flag F is “1”, the gateway device 2 acquires untransmitted data indicated by the transfer completion record TR from the terminal apparatus 1 for transfer to the server 3. The server 3 transfers the transfer completion record TR indicating last data registered for the terminal apparatus 1, that is, last data of transfer-completed data to the terminal apparatus 1 via the gateway device 2.

Since holding the transfer completion record TR from the server 3 as described above, the terminal apparatus 1 can immediately perform transmission in response to a request to transmit the transfer completion record TR from the gateway device 2. The gateway device 2 can identify data which is to be immediately transmitted based on the transfer completion record TR to send a data transmission request to the terminal apparatus 1.

Therefore, according to the above-described embodiment, it is possible to provide a communication system including a terminal apparatus and a data transfer apparatus configured to acquire information from the terminal apparatus for transfer to a server which is a data management apparatus, which can reduce a communication load between the data transfer apparatus and the data management apparatus and a processing load of the data management apparatus to efficiently transmit data of the terminal apparatus to the data management apparatus.

In the communication system of the above-described embodiment, although elderly people in care facilities, patients in hospitals, or the like are assumed as a user, measured data of whom is to be managed, the terminal apparatus 1 may be worn on an animal such as a pet.

Furtheitnore, the terminal apparatus 1 may be a moving body such as a robot, and the communication system of the above-described embodiment is also applicable to management of data such as temperature around the moving body.

Although a conventional system has a problem that power consumption of the gateway device 2 is high since a communication load between the gateway device 2 and the server 3 is large, and the battery's life is shortened when the gateway device 2 is driven by a battery. However, the above-described embodiment can reduce a communication load of the gateway device 2 with the server 3, which leads to the longer battery life of the gateway device 2.

Furthermore, the above-described data transfer procedure can be used to easily and rapidly transfer predetermined event information from the terminal apparatus 1 to the server 3.

For example, the terminal apparatus 1 is provided with a button 35A as shown by a dotted line in FIG. 3 to enable the user to operate the button 35A. That is, the terminal apparatus 1 is provided with the button 35A as at least one operation member for a predetermined operation. Here, the button 35A is, for example, an “SOS” button which is operated in order to inform the server 3 of occurrence of an emergency such as falling of the user.

When the user operates the button 35A, the control unit 31 sets the above-described transfer data existence flag SF to “1”. That is, when the button 35A is operated, the terminal apparatus 1 includes the flag F which is data existence information in the advertising packet ADP which is an existence notification signal.

When the terminal apparatus 1 is in a state in which short-range wireless communication with the gateway device 2 is available, the terminal apparatus 1 transmits predetermined information indicating “SOS” to the gateway device 2 instead of the above-described measured data. Since the gateway device 2 performs transmission to the server 3 through the Internet, an effect is also provided that a manager of the server 3 is immediately informed, and the manager can quickly respond the user's SOS or the like.

Note that data such as an activity amount may also be calculated and obtained from an output signal of the acceleration sensor although measured data of the terminal apparatus 1 in the above-described embodiment is a step count, calorie consumption, a pulse, an ultraviolet amount and body surface temperature.

Although, in the above-described embodiment, the short-range wireless communication between the terminal apparatus 1 and the gateway device 2 is communication based on Bluetooth (registered trademark), other short-range wireless communication may be used.

Furthermore, although, in the above-described embodiment, wireless communication between the gateway device 2 and the server 3 is wireless telephone communication for cellular phones, WiFi or short-range wireless communication in a 900 MHz band may be used.

The present invention is not limited to the above-described embodiment, and various modifications, variants, and the like are possible in a range which does not change the gist of the present invention.

What is claimed is:

1. A communication system comprising:
a terminal apparatus configured to intermittently transmit an existence notification signal through short-range wireless communication in a broadcast manner, and hold predetermined information to be transmitted; and
a data transfer apparatus configured to, upon receiving the existence notification signal through the short-range wireless communication, determine whether the terminal apparatus includes the predetermined information or not, and when the terminal apparatus includes the predetermined information, acquire the predetermined information from the terminal apparatus through the short-range wireless communication for transfer to a data management apparatus, and transmit to the terminal apparatus a reception acknowledgement signal indicating receipt of the predetermined information by the data management apparatus.

2. The communication system according to claim 1, wherein
data existence infonnation indicating that the predetermined information exists can be integrated into the existence notification signal,
when the predetermined information exists, the terminal apparatus includes the data existence information in the existence notification signal for transmission, and
when the data existence information is included in the existence notification signal received through the short-range wireless communication, the data transfer apparatus deteinmines that the terminal apparatus includes the predetermined information, acquires the predetermined information through the short-range wireless communication, and transfers the predetermined information to the data management apparatus.

3. The communication system according to claim 2, wherein
the terminal apparatus includes at least one sensor, and
the predetermined information is measured data measured by the at least one sensor, and is data not yet transmitted to the data management apparatus.

4. The communication system according to claim 3, wherein
the terminal apparatus includes the data existence information in the existence notification signal when an amount of the untransmitted data is equal to or greater than a predetermined amount.

5. The communication system according to claim 3, wherein
upon receiving a transfer completion record indicating a range of data already transferred to the data management apparatus from the data management apparatus as the reception acknowledgement signal, the data transfer apparatus transfers the transfer completion record to the terminal apparatus,
the terminal apparatus holds the transferred transfer completion record as the reception acknowledgement signal, and
the data transfer apparatus acquires the transfer completion record from the terminal apparatus, and acquires the untransmitted data from the terminal apparatus based on the acquired transfer completion record for transfer to the data management apparatus.

6. The communication system according to claim 2, wherein
the tenuinal apparatus includes at least one operation member, and
when the operation member is operated, the terminal apparatus includes the data existence information in the existence notification signal.

7. The communication system according to claim 1, wherein
the existence notification signal includes group information, and
when the group information matches predetermined group information, the data transfer apparatus acquires the predetermined infoiiiiation from the terminal apparatus for transfer to the data management apparatus.

8. The communication system according to claim 1, wherein
the short-range wireless communication is communication according to a Bluetooth (registered trademark) standard, and
the existence notification signal is an advertising packet in the Bluetooth (registered trademark) standard.
